(19) United States
(12) Patent Application Publication
(10) Pub. No.: US 2024/0105395 A1
(43) Pub. Date: Mar. 28, 2024

(54) Atomically Precise Nanostructures and Applications Thereof

(71) Applicant: Olanrewaju Tanimola, Sugar land, TX (US)

(72) Inventor: Olanrewaju Tanimola, Sugar land, TX (US)

(21) Appl. No.: 17/936,122

(22) Filed: Sep. 28, 2022

(51) Int. Cl. H01G 11/26; B82B 3/00

(52) U.S. Cl. CPC H01G 11/26; B82B 3/0014; B82Y 30/00

(57) ABSTRACT

The present invention is a method for fabricating clean technology products. It discloses composition comprising: a network of one or more nanostructures having a lattice structure formed by (ASU)n, ASU is asymmetric unit, n>0, the one or more nanostructures of the present invention comprise a selection from the group consisting of 0D, 1D, 2D, carbon, inorganic, and any combinations thereof, the lattice structure of the present invention is selected from a cubic system, a rhombohedral system, an orthorhombic system, monoclinic system, and triclinic system, where ASU is selected from (HwTxLyMz) H is hydrogen, T is an alkaline metal, L is a chalcogen, O is oxygen, w>=0, x>=1, y>=1, z>=0.

### CROSS-REFERENCE TO RELATED APPLICATIONS

This application claims the benefit of the filing date of and priority to U.S. Provisional Application Ser. No. 62/035,140 entitled “Methods for Synthesis of Graphene Derivatives and Functional Materials from Asphaltenes”, filed Aug. 10, 2015, the entire contents of the said provisional application is hereby incorporated by reference.

### BACKGROUND OF THE INVENTION

### Field of the Invention

The present invention relates to atomically precise nanostructures and applications thereof. An embodiment of the present invention relates to a method for fabricating clean technology products including zero emission technologies (XET) and value-added negative emission technologies (VANET) i.e. value-added negative emission concretes (VANECRETE). Certain aspects of the present invention relate to novel materials for climate resiliency and climate change mitigation, as well as decarbonization of industrial sectors like transportation, energy, chemicals, buildings etc.

### Description of the Related Art

Retrofitting novel materials into existing architecture in a manner that synergizes circularity strategies with climate safety and resilience offers a richness of consequences in different perspectives. Most essentially, the achievement of net-zero emissions or incorporation of negative emission technologies is highly crucial to achieving a sustainable environment.

To certain extents, overcoming the limitations described in Moore's Law through Feynman's prediction provides a unique opportunity in various ways. The limitations of conventional materials i.e. organic, and inorganic in meeting existing demands for cleaner, more sustainable, and energy saving devices have triggered the need for robust techniques in material processing and design.

Although, biomolecular, and chemical approaches offer possibilities for the control and manipulations of these materials at atomic scale, experimental methods to design and synthesize compositions comprising active sites with specific extended architectures, which maintain the required organization of weakly bound molecules during interactions or contacts are not yet available.

Devices or compositions with active sites at specific locations in their supramolecular surroundings are elusive.

### SUMMARY OF THE INVENTION

An aspect of the present invention relates to the adsorption of GHG gases.

The present invention is a climate mitigation and resiliency products made from an atomically precise nanostructure.

The present invention is an atomically precise nanostructure comprising a network of one or more nanostructures having a lattice structure formed by (ASU)n.

An object of the present invention is an atomically precise nitrogen containing nanostructures (NANOMINES)

The one or more nanostructures of the present invention comprise a selection from the group consisting of 0D, 1D, 2D, carbon, inorganic, and any combinations thereof.

The lattice structure of the present invention is selected from a cubic system, a rhombohedral system, an orthorhombic system, monoclinic system, and triclinic system.

The present invention is a composition comprising a network of one or more non-carbon nanostructures having a lattice structure formed by (ASU)n.

The present invention is a climate mitigation and resiliency composition made from a composition comprising a network of one or more carbon nanostructures having a lattice structure formed by (ASU)n. where ASU is asymmetric unit and n>=1, where ASU is (CxHyF) wherein x=6 or 7, 3≤y≤6 and F is one or more functional groups selected from the group consisting of one or more nitrogen groups, one or more sulfur groups, one or more hydroxyl groups, one or more OR groups, one or more NHOR groups, one or more halogen groups, one or more halide groups, one or more NR₂ groups, one or more SO₃H groups, one or more sulfide groups, one or more azo groups, one or more sulfonate groups, one or more CN groups, one or more CH₃ groups, one or more N₂O₄ groups, one or more O₃SH₃O groups, one or more SO₂ groups, one or more NO₂ groups, one or more NR₃ groups, one or more amide groups, one or more carbonyl groups, one or more oxygen groups, one or more ketone groups, one or more ester groups, one or more carboxyl groups, one or more alkyl groups, one or more acyl groups, one or more carboxylate groups, and combinations thereof.

The present invention discloses methods for synthesis of 2D non-carbon nanomaterials from materials with complex structure e.g. asphaltenes.

The present invention discloses methods for synthesis of 2D complex oxides from materials with complex structure e.g. asphaltenes.

The present invention discloses methods for synthesis of reduced 2D complex oxides from materials with complex structure e.g. asphaltenes.

The present invention discloses a composition comprising a network of one or more non-carbon nanostructures having a lattice structure.

The present invention is a composition comprising a network of one or more inorganic nanostructures having a lattice structure formed by (ASU)n, where ASU is asymmetric unit and n>=1, where ASU is selected from (HwTxLyMz) H is hydrogen, T is an alkaline metal, L is a chalcogen, O is oxygen, w>=0, x>=1, y>=1, z>=0.

The lattice is formed by (ASU)n, where ASU is asymmetric unit and n>0, where ASU is (TₓL_{y}M_{z}) where T is an alkaline metal, L is a chalcogen, M is oxygen, x is equal to or greater than 1, 2, y=1, z=0 or 4.

The lattice is formed by (ASU)n, where ASU is asymmetric unit and n>0, where ASU is (TₓL_{y}M_{z}H_{w}) where T is an alkaline metal, L is a chalcogen, M is oxygen, D is hydrogen, x=1, y=1, z=4 or 5, w=1 or 3.

An example of present invention disclosed composition is a composition comprising a network of one or more 2D nanostructures having lattice formed by an asymmetric unit (ASU)n, where ASU is a hydrated or an anhydrous form of a selection from NaSO₅, Na₄S₂O₈.

An example of present invention disclosed composition is a composition comprising a network of one or more 2D nanostructures having lattice formed by an asymmetric unit (ASU)n, where ASU is a hydrated or an anhydrous form of a selection from NaSO₅H₃, NaSO₄H, Na₇S₂O₁₀H₃, Na₇S₂O₈H, NaS₂O₆H₃.

An example of present invention disclosed composition comprising a network of one or more 2D nanostructures having a lattice formed by an asymmetric unit (ASU)n, where ASU is selected from Na₂S, Na₂S₄ or NaSH.

An object of the present invention relates to the use of the disclosed compositions of the present invention.

An object of the present invention relates to fabrication of clean technology product comprising a selection from the group consisting a battery component, a negative emission product, a value added negative emission product, a structure material, a supercapacitor component, a cable component, an adsorbent, a carbon capture component, a fuel cell component, a water splitting material, a hydrogen storage component, a therapeutic platform, a diagnostic device, a sensing device component, an anolyte, a catholyte, paints and coatings, plastics, composites, building materials, an anode, a cathode, an electrolyte, a transistor, an energy conversion material, an adsorbent, a structure material, a therapeutic component, a diagnostic component, an energy storage material, a sensor, a catalyst, a photonic material, membrane, battery technologies a thermoelectric material, a solar cell component, an automobile component, a substitute for rare earth metal, a semiconductor, a superconductor, a lightning material, a thermal management material, electromagnetic interference shielding, a wearable material, a printable material, a flexible material, a membrane material, a nanocomposite, a transparent insulator, a diode, a thermoplastic, an elastomer, or a combination thereof

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 shows a transmitted electron intensity profile of a network of one or more carbon nanostructures along the periodicity. The average interlayer distance of the nanostructures of present invention is 0.367 nm±10 nm.

FIG. 2 shows a transmission electron microscopy image of a network of one or more carbon nanostructures

FIG. 3 shows a supramolecular structure of a network of one or more 1D carbon nanostructures having asymmetric unit C₇H₁₀SO₄ when viewed down the section

FIG. 4 shows a supramolecular structure of a network of one or more 2D carbon nanostructures having asymmetric unit C₆H₄N₂O₄ when viewed down the section.

FIG. 5 shows a supramolecular structure of a network of one or more 2D inorganic nanostructures having an asymmetric unit of Na₄S₂O₈.

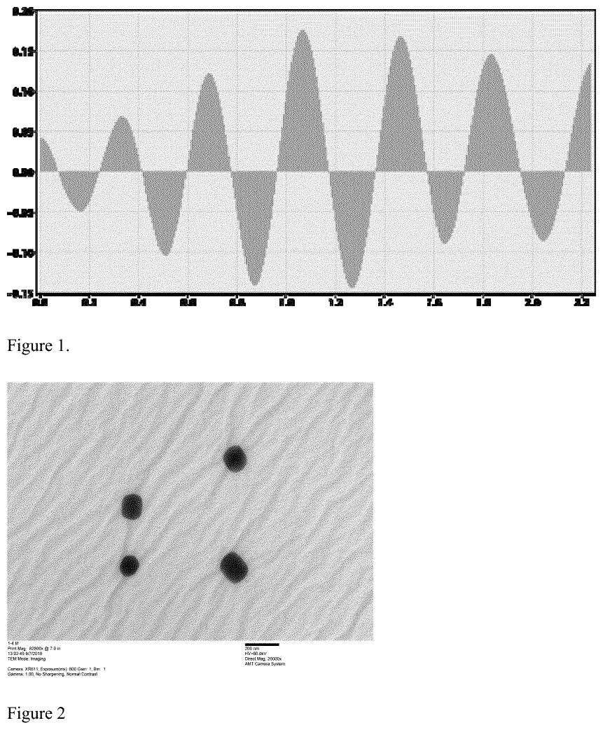

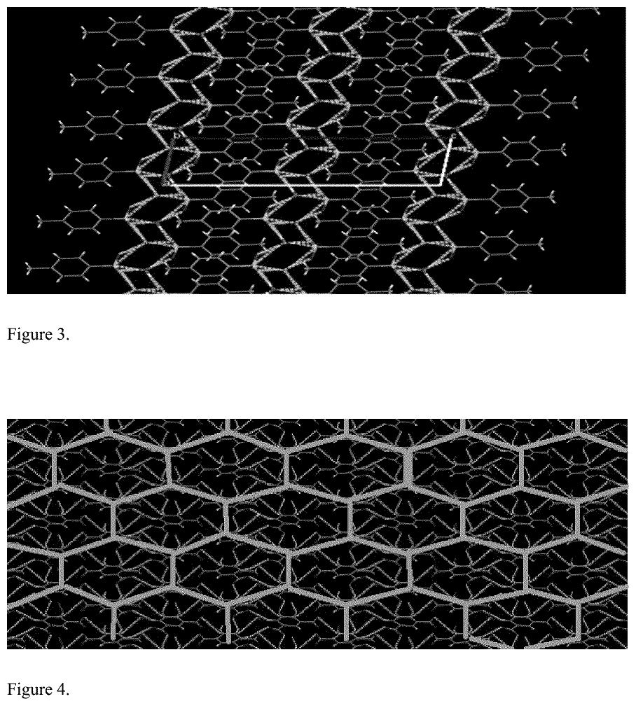

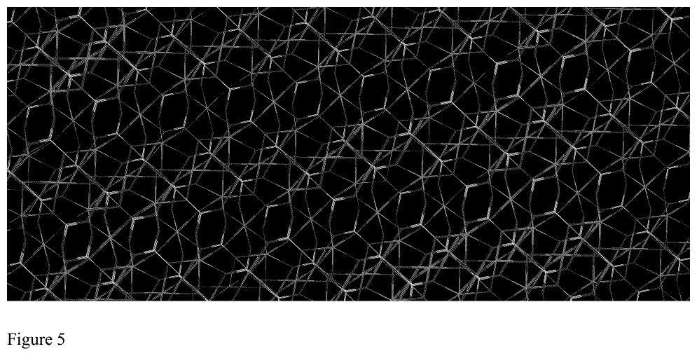

The one or more nanostructures of the present invention is selected from 0D, 1D, 2D, and any combinations thereof.

The lattice structure of the present invention is selected from a cubic system, a rhombohedral system, an orthorhombic system, monoclinic system, triclinic.

### DETAILED DESCRIPTION OF THE INVENTION

According to the International Panel on Climate Change (IPCC), approximately 10 gigatons of net CO2 removal per year must be achieved by the year 2050 in order to keep global temperature rise under 1.5 or 2C. Climate change is the consequential effect of redistribution of carbon among carbon pools. In the United States, combustion of fossil fuels to produce electricity accounts for 40% of emitted CO₂, with another 30% contributed by industrial processes, and 30% from transportation. If current societal practices are sustained, the global average temperature could increase by 6° (C.) before the end of the year 2100. To address this climate change challenge, an estimated gigaton-scale of carbon needs to be removed from the earth within the next decades in a manner that does not add greenhouse gases. The transition from chemistry to biology via mimicking nature's ability to self-replicate is could unlock numerous techniques for climate mitigation and resiliency. Biology offers even greater inspiration for creating hierarchical materials with multiple functionalities to enable emergent phenomena that are more than the sum of the actions of individual functionalities. For example, to allow chemical transformations at ambient temperature and pressure, enzymes explore the constrained space of active sites, the multifunctionality of active sites, and channels of designed size to transport reactants. Based on de novo synthesis and origin of life, the functional integration of three key characteristics—replication, metabolism and compartmentalization are vital to gaining useful insight into biological mechanisms of self-replication.

Structural uniformity, purity, control, and accurate prediction of the location of atoms are critical to the manufacturing of atomically precise structures and devices. Similarly, the synthesis of a device or structure that enables precise positioning of every atom relative to the other atoms, and in a regularly ordered manner could revolutionize several technologies. Such architectures are ideal building blocks for a variety of functional materials due to their unique and anisotropic optical, electronic, magnetic, and mechanical properties. Atomically Precise structures (APS) are vital to the creation of stronger and more exotic new generation of materials. Although positionally controlled processes promote the formation of greater complex structures, scale-up is readily accomplished with self-assembly techniques.

The use of atomically precise nanostructures or self-replicating nanostructures for the deliberate construction of both molecular complexes and solid materials could address existing limitations in carbon capture and storage (CCS), carbon capture utilization and sequestration (CCUS), structure materials, energy generation, energy storage, biomedical systems, therapeutic, diagnostic, sensing, cables, superconductors, fuel cells, hydrogen production and storage, conductors, lasers, packaging, electronics, batteries, etc.

However, despite availability of a plethora of processing techniques for carbon capture, there is still a need for low-cost and high-performance carbon capture materials. Ability to selectively capture large volume of carbon from a point source or ambient and operate under low temperature is a valuable proposition. Also, functionalities like low-temperature carbon release preferable in the range of waste heat temperature and high cycling capacity are highly sought.

Other options for carbon removal involve the utilization of CO2 in a manner that promote net zero emissions. Currently, there exist numerous platforms for CO2 usage including use as a feedstock for technologies like plastic, carbon, energy, and buildings. Due to long storage duration, storing CO2 in buildings is often considered the most effective method for carbon removal.

On the other hand, because of the impact of climate change, numerous transformational concepts are developing across several industries. For example, conventional energy industries are transitioning to clean energy systems including renewable energy, batteries, supercapacitors, fuel cells.

Insights gained from existing efforts in catalysis, membranes, clean energy, biotechnology, and structure materials provided various possibilities for optimization of existing architectures. There is a need to develop techniques that can facilitate optimum precise spatial control of multiple binding sites and of the shape, size, location and chemical properties of voids, ligands, and solvents. Nanostructures with varying configurations along different planar directions synthesized from large, and complex self-assembled nanostructures are leading candidates for the advancement of clean technologies. The discovery of complex materials that can serve as suitable feedstocks and effective synthetic route could lead to a robust advancement in clean technologies. In that regard, nanostructures derived from an asphaltene composition or a complex structure can be incorporated into a wide range of atomically precise technologies. An aspect of the present invention relates to atomically precise nanostructures derived from asphaltenes and their application in clean technologies

### I. Asphaltenes

Asphaltenes represent a chemically complex and structurally heterogeneous group of organic molecules that are present in crude oil. Asphaltenes are typically characterized as macromolecules with rigid core aromatic rings and flexible alkyl chains with a variable number of heteroatoms and metals (Andersen and Speight, 1999, Jour. Pet. Sci. Eng., 22, 53-60). Asphaltenes typically contain oxygen (0.3-4.8%), sulfur (0.3-10.3%), nitrogen (0.6-3.3%), and small amounts of metals, such as Fe, Ni, and V (Buch et al., 2003, Fuel, vol. 82 (9), 1075-1084; Groenzin and Mullins, 2000, Fuels, 14 (3), 677-684). The presence of electronegative heteroatoms like nitrogen or oxygen in the structure of asphaltene results in an asphaltene being a strong hydrogen bond acceptor and weak hydrogen bond donor, which allows for the use of a dispersant when working with asphaltenes. Strong acids become effective asphaltene dispersants if their alkyl tails are long enough to provide the necessary steric-stabilization layers around the asphaltenes. Besides, organic salts may be strong donors of the hydrogen bonding and may also instill stability on asphaltenes structure. It is apparent that the pH of a solution is a determining factor. In another embodiment long alkyl chain compounds are employed for the dispersion of asphaltene. In certain aspects asphaltenes are reacted with an oxidizing acid. An oxidizing acid is a BrØnsted acid that is also a strong oxidizing agent. All BrØnsted acids can act as oxidizing agents because the acidic proton can be reduced to hydrogen gas. Some acids contain other structures that act as stronger oxidizing agents than hydrogen ion. They contain oxygen in the anionic structure. These include, but are not limited to nitric acid, perchloric acid, chloric acid, chromic acid, and sulfuric acids

### II. Isolation/Separation of Asphaltenes

There are several methods for characterizing crude oil components, as well as isolating and identifying asphaltenes. In certain methods the isolation of asphaltenes is initiated by precipitation of asphaltenes followed by the purification of the asphaltene precipitate. In a further aspect the asphaltenes can be solubilized prior to or after precipitation.

One example of isolating asphaltene from crude oil comprises dissolving crude oil in heptane. Stirring the heptane/crude oil mixture for about 48 hours at room temperature. Filtering the mixture through filter paper and rinsing the filtrate using toluene. The filtered solution is dried and a crude asphaltene composition collected from the filter.

The crude asphaltene preparation can then be further purified. Crude asphaltene is dissolved in toluene and stirred for about 5 hours. The stirred solution is filtered, using for example filter paper no. 40. Purified asphaltene passes through the filter paper while impurities remain on the filter. The filtered asphaltene solution is dried at room temperature. The result is purified asphaltene that is typically a black shiny product. This product can then be further derivatized using the methods described herein.

Depending on the particular asphaltene starting material, it should be appreciated that the structure of asphaltene extracted from contemplated methods may vary considerably.

### III. Asphaltene Derivatization

The present invention is a composition comprising a network of one or more inorganic nanostructures having a lattice structure formed by (ASU)n, where ASU is asymmetric unit and n>=1, where ASU is selected from (HwTxLyMz) H is hydrogen, where T is an alkaline metal, L is a chalcogen, O is oxygen, w>=0, x>=1, y>=1, z>=0.

An example of the disclosed composition of present invention is a composition comprising a network of one or more 2D nanostructures having lattice formed by an asymmetric unit (ASU)n, where ASU is selected from NaSO₅H₃, NaSO₄H or Na₄S₂O₈

An example of the disclosed composition of present invention is a composition comprising a network of one or more 2D nanostructures having a lattice formed by an asymmetric unit (ASU)n, where ASU is selected from Na₂S, Na₂S₄ or NaSH

An embodiment is a method of producing a network of one or more inorganic nanostructures comprising: providing an asphaltene composition and performing one or more process steps selected from: refluxing the asphaltene composition with one or more additives to form a nanostructured composition, contacting the nanostructured composition with one or more modifying agents to form a modified nanostructure, contacting the nanostructured composition or the modified nanostructure with a controlling agent to form a controlled nanostructure. purifying to remove impurities.

An embodiment is a method of producing a network of one or more inorganic nanostructures comprising: providing an asphaltene composition and performing one or more process steps selected from: refluxing the asphaltene composition and one or more surfactants, refluxing an asphaltene composition and one or more dispersants, refluxing an asphaltene composition and one or more additives, performing one or more reduction steps on a processed asphaltene composition.

The surfactant comprises a sulfonic acid composition or alkyl sulfonic acid oxonium salt.

The dispersant comprises a selection from p-alkylphenols, p-alkylbenzenesulfonic acid, or alkyl sulfonic acid.

Prior art described surfactants; WO 2013/165869 is incorporated herein for all purposes of the processing.

Prior arts disclosed a large number of reductants such as: hydrogen sulfide, sodium borohydride, hydrazine, an alkaline solution, sodium citrate, amino acids, sugars, ascorbic acid, thermal energy, electromagnetism, polyphenols, tea, and microorganisms have been reported

An object of the present invention is a recycling method that involves the use of spent materials or a by-product as feedstock.

The feedstock of the present invention is an additive and a selection from the group consisting of complex materials. layered materials, stacked materials, asphaltenes, two dimensional materials, molybdenum sulfide, boron nitride, chemical reagents, carbon slurry, graphitic compounds, soot, lignite, peat, layered materials, PAH compounds, resin, graphite, petrified oil, asphalt, bitumen, modified bitumen, coal, modified coal, modified asphaltenes, anthracite, modified anthracite and combinations thereof.

Another embodiment is directed to the use of an additive that is selected from surfactants, intercalating agents, coupling agents, catalysts, acids, oxidizing agents, reducing agents, solvents, sulfonic acid derivatives, composites, hydrocarbons, dispersing agents and any combination thereof.

Another embodiment of the invention involves the derivatization of asphaltene by aromatization, functionalization, surface modification, dimerization, electrophilic aromatic substitution, nucleophilic aromatic substitution, desymmetrization, hydrogenation, nitration, sulfonation halogenation recrystallization, esterification, reduction, oxidation, and combinations thereof.

In one embodiment the invention relates to a facile and cheaper method for producing graphene derivatives. In certain aspects the invention discloses methods of producing functional materials and graphene derivatives.

An embodiment of the invention discloses a range of products that include graphene derivatives and functional materials that exhibit different properties and morphologies. The range of properties of the products include optical, thermal, electrical, magnetic, chemical, mechanical, biological, astrological, physical, etc.

In an embodiment the invention methods of derivatization of aromatic compounds are adapted. Organic chemistry taught methods for derivatization of aromatic compounds. In certain aspect the invention adapted methods substitution methods for the derivatization of aromatic compounds like nitrobenzene, amines, amino acids, alcohols.

An embodiment of the invention adapted substitution reactions comprising without limitation nitration, sulfonation, sulfation, Friedel crafts alkylation, Friedel craft acylation, Sandmeyer reaction, halogenation, hydrogenation, and any combination. In certain aspect present invention envisioned that the replacement of hydrogen with functional group may result in the formation of many derivatives.

Another embodiment of the invention relates to the use of dispersant, asphaltene studies taught the use of surfactants or ionic liquids (Journal of Petroleum Engineering Volume 2013 (2013)) aromatic (J Colloid Interface Sci. 2015 Feb. 15; 440:23-31) and sulfonic derivatives (U.S. Pat. No. 7,579,303 B2) as asphaltene dispersant.

In one embodiment the invention describes method of modifying the any or a combination of edges, sides and terminal ends of asphaltene derivatives with electron donating functional groups like NR₂, NH₂, OH, OR, alkyl, NHOR, and halides and electron withdrawing group like COR, SO₂, OH, NO₂, CN and NR₃.

An embodiment of the invention discloses the economic potential of the process in terms of materials continuous flow reactions that enables the recycling of the by-products.

In another embodiment the dispersion method involves a range of processing techniques not limited to mixing, nitration, oxidation, reduction, halogenation, coupling, sulfonation, diazotization, hydrogenation and any combination thereof.

The starting material may include crude asphaltene or treated asphaltenes e.g., thermally treated asphaltenes, milled asphaltene, mechanically treated, thermo-mechanically treated asphaltene as starting material.

The term “additive” include of heteroatom containing surfactants, acids, mixed acids, solvents, organic solvents, antifoulants, coagulants, flocculants, solubilizing agents, antifoaming agent, emulsifying agents, dispersing agents, ionic liquids, salts, oxidizing agents, reducing agents, catalysts, amphiphilic solvents, dispersants, oxidants, acids, polymer copolymer, biological macromolecules, acidic solution, DNA, protein molecules, organic solvents, polar solvents, non-polar solvents, aromatic solvents, water, alcohol, alkane, acidic ionic liquids and combinations thereof.

In certain aspects the intercalating agents or additives may be selected from any of but not limited to nitric acid, sulfuric acid, aromatic solvent, polar solvent, methanol, water, peroxide, formic acid, benzene, toluene, naphthalene, nitrobenzene sulfonic acid, linear alkyl sulfonic, polytetrafluoroethylene, sodium nitro sulfonic acid, sodium dodecyl sulfate, cetyltrimethylammonium bromide, phospholipid, lignin, sulfuric acids, ammonia, taurine, tetrahydrofuran, sulfur trioxide, carboxylic acid, acetic acid, carboxylic acids, sulfonic acids and derivatives, carbonic acids, nitro-sulfonic acids, oleic acid, methyl cellulose, diethylene glycol, polyoxyethylene sorbitan monolaurate, hydrogen peroxide, oxalic acid, perchloric acid, iron bromide, iron chloride, phosphoric acid, hydrofluoric acid, chlorosulfonic acid, trifluoromethanesulfonic acid, nickel, iron, vanadium, permanganate, oleum, chloride, chlorite, nitrite, potassium permanganate, methanol, acetone, water, propanol, isopropanol, dimethyl sulfoxide, polyethylene glycol (PEG), polymer copolymer (PEtOz-Pcl), alkyl phenol, water, Dodecyl benzenesulphonic acid, methanol, tetrachloromethane, taurine, methionine, trichloromethane, tetrahydrofuran, N-(3-dimethylaminopropyl), N′ethyl-carbodiimide hydrochloride, N′hydroxyl succinimide, poly-lysines (PLs), sodium dodecyl benzenesulfonate, platinum, sodium oleate, cysteine, homocysteine, or mixtures thereof.

A modifying agent or modifier refers to a solvent that contributes to the tuning of the surface or interphase of the refluxed asphaltene solution. A modifier is introduced to alter the edges of the asphaltene emulsion. Such action may result in the change in the structural dimension. In certain aspect a modifier performs several operations that include without limitation addition of functional group(s), elimination of the functional group(s), and substitution of functional group(s).

The modifier may comprise without limitation metal catalyst, basic solution, a reducing agent, a salt solution, metal oxides, sulfides, hydrides and any combination thereof. In certain aspects a modifier is selected from any of sodium chloride, sodium hydroxide, ammonium hydroxide, hydrochloric acid, tetrahydrofuran, amino triazole, dimethylformamide, dimethylsulfoxide, phosphines, phosphites, sulfites, sulfides, hydrosulfites, borohydrides, boranes, hydroxylamine, lithium alhydride, sodium nitrite, hydrochloric acid, thermal, electromagnetic, magnetic, optical, mechanical, lasering, heating, cooling, copper bromide, copper cyanide, potassium iodide, borohydrides, hydrochloric acid, cyanoborohydrides, aluminum hydrides, hydroquininone, hydrogen dimethylhydrazine, N,N-dimethylhydroxylamine, methylamine, dioxane, amino acids, dimethylamine, trimethylamine taurine, methionine, potassium hydroxide, tin, methanol, alkali sulfide, distilled water, or mixtures thereof.

A controlling agent is added to the solution when there is a need to neutralize the reaction in order to obtain a stable composition. The controlling agent may also modify the pH of the solution. The selection of a controlling agent is dependent on the pH of the solution; the controlling agent is selected from any of hydrochloric acid, sodium bicarbonate, methanol, dimethyl sulfoxide, electromagnetic, heating, cooling, lasering, sodium hydroxide, potassium hydroxide, tetrahydrofuran, dimethylformamide, alkali sulfide, dimethylsulfoxide, phosphines, phosphites, sulfites, sulfides, dioxane, hydrosulfites, borohydrides, boranes, distilled water, sodium bicarbonate or mixtures thereof.

In certain aspects surfactants, sulfonic derivatives, mixed acids, nitric acid, sulfuric acid, sodium hydroxide, and hydrochloric acid can be used in the methods described. However, other reagents with similar characteristics can also be used in place of these reagents.

An embodiment of the invention relates to methods comprising an additive reactor or mixer, a modification reactor, control reactor, separation, and recrystallization channel.

### IV. Methods for Climate Change Mitigation and Resiliency

An embodiment is a reactive carbon reaction for producing a structure material comprising one or more steps selected from: contacting an asphaltene composition with a composition comprising CO₂ to form reactive carbon product, contacting the reactive carbon product with a modifying agent to form a modified carbon product, contacting the modified carbon product with a controlling agent to form a controlled carbon product, and purifying the product.

An embodiment is reactive carbon reaction comprising contacting a network of one or more nanostructure of the present invention with a composition comprising CO 2 to form a reactive carbon product.

An embodiment to relates to a method of fabricating a clean technology product comprising: performing at least a process step of contacting a reactive carbon product with a selection from one or more building materials, one or more biomass materials, one or more waste materials, one or more additives, one or more printable materials.

An embodiment relates to relates to a method of fabricating a clean technology product comprising: performing at least a process step of contacting a reactive carbon product with a selection from the group consisting of aggregates, fly ash, steel slag, cement, soda, plastic, water, metal, ceramic, organic material, or any combinations thereof.

An embodiment of the present invention relates to recycling of graphene compositions from a spent material using asphaltene derivatization method.

An embodiment relates to a method of fabricating a clean technology product comprising: forming at least one component by contacting an atomically precise nanostructure or a previously stated product of the present invention with a selection from silicon, a silicon precursor, a sulfur composition, a substrate, a printable material, or a combination thereof.

An embodiment relates to a method of fabricating an energy storage or energy production device comprising: forming at least one component by contacting an atomically precise nanostructure or a previously stated product of the present invention with a selection from silicon, a silicon precursor, a sulfur composition, a substrate, a printable material, or a combination thereof.

An embodiment relates to a method of fabricating a catalytic device comprising: forming at least one component by contacting an atomically precise nanostructure or a previously stated product of the present invention with a selection from silicon, a silicon precursor, a sulfur composition, a substrate, a printable material, or a combination thereof.

I claim:

1. A composition comprising: a network of one or more nanostructures having a lattice structure formed by (ASU)n, ASU is asymmetric unit, n>0, the one or more nanostructures of the present invention comprise a selection from the group consisting of 0D, 1D, 2D, carbon, inorganic, and any combinations thereof, the lattice structure of the present invention is selected from a cubic system, a rhombohedral system, an orthorhombic system, monoclinic system, and triclinic system, where ASU is selected from (HwTxLyMz) H is hydrogen, T is an alkaline metal, L is a chalcogen, O is oxygen, w>=0, x>=1, y>=1, z>=0.

2. The composition according to claim 1, further comprising ASU is (TxLyMz) where T is an alkaline metal, L is a chalcogen, M is oxygen, x is greater than zero less than or equal 7, y is greater than zero less than or equal 4, z is greater than zero less than or equal 8.

3. The composition according to claim 1, further comprising ASU is (TxLyMzHw) where T is an alkaline metal, L is a chalcogen, M is oxygen, H is hydrogen, x is greater than zero less than or equal 7, y is greater than zero less than or equal 4, z is greater than zero less than or equal 8, w is greater than zero less than or equal 3.

4. The composition according to claim 1, further comprising ASU is (TxLy) where T is an alkaline metal, L is a chalcogen, x is greater than zero less than or equal 7, y is greater than zero less than or equal 4.

5. A method of fabricating a clean technology system comprising forming at least one component by contacting a reactive carbon component with a selection from silicon, a silicon precursor, a sulfur composition, a substrate, a printable material, or a combination thereof.

6. A method of fabricating an energy storage or energy production device comprising: forming at least one component by contacting a reactive carbon product or an atomically precise nanostructure with a selection from silicon, a silicon precursor, a sulfur composition, a substrate, a printable material, or a combination thereof.
